(19) United States
(12) Patent Application Publication
(10) Pub. No.: US 2024/0209218 A1
(43) Pub. Date: Jun. 27, 2024

(54) COLORANT CONTAINING ENCAPSULATED COPPER AS AN IN-CAN PRESERVATIVE

(71) Applicant: BASF SE, Ludwigshafen am Rhein (DE)

(72) Inventors: Christopher J. VALOVIC, Charlotte, NC (US); Nicole M. REINARTZ, Charlotte, NC (US); Alan H. KOHEN, Charlotte, NC (US)

(21) Appl. No.: 18/392,542

(22) Filed: Dec. 21, 2023

Related U.S. Application Data
(60) Provisional application No. 63/434,582, filed on Dec. 22, 2022.

(51) Int. Cl. C09D 5/14; A01N 25/28; A01N 59/20; A01P 15/00; C09D 11/037

(52) U.S. Cl. CPC C09D 5/14; A01N 25/28; A01N 59/20; C09D 11/037; A01P 15/00

(57) ABSTRACT

The present disclosure provides an aqueous pigment composition comprising a pigment and a metal-based biocide. Specifically, the present disclosure provides an aqueous pigment composition including a glass-encapsulated copper biocide. The composition may be used in paints for distribution at the point of sale.

### BACKGROUND

Modern low VOC (volatile organic compound) colorants are aqueous pigment dispersions that contain little or no organic solvents. Removal of solvents and other organic additives to lower VOC has made it more difficult to control bacteria and fungi growth in the colorants. High levels of biocides and fungicides may be needed to preserve the material while it is stored in bottles over a 1-2 year shelf life, and allow it to remain protected when the bottles are opened and poured into the Point of Sale (POS) dispenser.

However, there are concerns regarding safety for those exposed to biocides and fungicide. In addition, there is a concern that a biocide and/or fungicide could degrade over time, thus not protecting the colorant during storage, transportation, and consumption at retail stores. Therefore, an improvement over the current method is desired.

### DETAILED DESCRIPTION

### I. Definitions

Prior to describing the invention in further detail, the terms used in this application are defined as follows unless otherwise indicated.

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

“Optional” or “optionally” means that the subsequently described circumstance may or may not occur, so that the description includes instances where the circumstance occurs and instances where it does not.

The term “pre-determined” refers to an element whose identity is known prior to its use.

The terms “essentially VOC free” or “low VOC” means a concentration of volatile, organic compounds of less than 25 g/L according to ASTM D6886.

The term “pigment component” relates to pigments and mixtures of at least one pigment and/or at least one filler.

The term “point-of-sale” means a site at which custom-mixed paints, varnishes or renders are tinted and mixed in small lots for sale to end-users.

Before the present invention is described in greater detail, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrecited number may be a number which, in the context in which it is presented, provides the substantial equivalent of the specifically recited number.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

### II. Colorants

Liquid systems, such as coating materials, varnishes, emulsion paints, and printing inks are customarily pigmented using pigment compositions comprising water, organic solvent or combinations thereof. In addition to anionic, cationic, nonionic or amphoteric dispersants, these pigment compositions must generally be admixed with further auxiliaries, such as humectants, agents for increasing the freeze resistance, thickeners, preservatives and defoamers, for stabilization.

Such pigment compositions are employed as tinting pastes in retail stores and professional decorating businesses, and, using metering and tinting systems, are added to aqueous and solvent borne inks and paints in order to set customer-specific shades. Such pigment compositions are usually called universal pigment compositions, as they may be used to tint both aqueous/waterborne and solvent borne coating materials. For the precise setting of a particular shade, the tinting pastes are generally metered volumetrically.

In order to comply with the guidelines for awarding of various eco labels, inks and paints have for some time advantageously been given low-VOC (volatile organic compounds) or VOC-free designations. The same standards are also desired for the pigment compositions which are mixed in at the point of sale to the low-VOC or VOC-free inks and paints.

The pigment compositions described herein are described further below, as well as in WO 2017/125556, which is herein incorporated by reference in its entirety.

The pigment compositions of the present disclosure may comprise a pigment component; a water-soluble additive such as a polyamine and/or one or more surface active wetting and dispersing additives, such as polycarboxylate salts, polycarboxylate ethers, maleic acid anhydride copolymers, fatty acid derivatives, ethoxylated alcohols, and copolymers with pigment affinic groups; an optional anionic additive based on a phosphoric ester and/or phosphonic ester; and water. Further optional additives may include humectants, rheology additives such as thickeners, further dispersants such as nonionic additives based on polyethers, wetting agents, defoamers, foam suppressants, preservatives such as biocides or fungicides, anti-flocculants, pigment synergists, buffer substances, pH regulators and the like.

Suitable pigments may include organic pigments comprising organic color and black pigments. Inorganic pigments may likewise be color pigments (chromatic, black and white pigments). Examples of suitable organic pigments include azo pigments, disazo pigments, disazo condensation pigments, anthanthrone pigments, anthraquinone pigments, anthra-pyrimidine pigments, quinacridone pigments, quinophthalone pigments, diketopyrrolo-pyrrole pigments, dithioketopyrrolopyrrole pigments, dioxazine pigments, flavanthrone pigments, indanthrone pigments, isoindoline pigments, isoindolinone pigments, isoviolanthrone pigments, metal complex pigments, perinone pigments, perylene pigments, phthalocyanine pigments, pyranthrone pigments, pyrazoloquinazolone pigments, indigo pigments, thioindigo pigments, triarylcarbonium pigments, carbon black pigments, titanium dioxide pigments, specialty pigments that provide functionality other than or in addition to color, and combinations thereof.

The pigments are customarily present in finely divided form. Accordingly, the pigments typically have average particle sizes in the range of about 0.1 um or greater, about 0.2 um or greater, about 0.3 um or greater, about 0.4 um or greater, about 0.5 um or greater, about 1 um or greater, about 1.5 um or greater, about 2 um or less, about 2.5 um or less, about 3 um or less, about 3.5 um or less, about 4 um or less, about 4.5 um or less, about 5 um or less, or any value encompassed by these endpoints.

The weight average particle diameter is usually determined by light scattering methods, e.g., by the method of ISO 13320:2009. The weight average particle diameter may be also determined by sieving analysis.

The pigment may be present in an amount of about 1 wt. % or greater, about 5 wt. % or greater, about 10 wt. % or greater, about 15 wt. % or greater, about 20 wt. % or greater, about 25 wt. % of greater, about 30 wt. % or greater, about 35 wt. % or greater, about 40 wt. % or less, about 45 wt. % or less, about 50 wt. % or less, about 55 wt. % or less, about 60 wt. % or less, about 65 wt. % or less, about 70 wt. % or less, about 75 wt. % or less, about 80 wt. % or less, or any value encompassed by these endpoints, as a percentage of the total aqueous composition.

Suitable water-soluble additives may include polyamines such as polyvinylamines, poly-C2-C3-alkyleneimines, modified poly-C2-C3-alkyleneimines, melamines, modified melamines, poly-(C2-C4-alkyleneether) amines, polyetheramine polyols, and modified polyetheramine polyols, for example.

The polyamine may have a number average weight (Mn) of about 200 Daltons or greater, about 500 Daltons or greater, about 1000 Daltons or greater, about 2500 Daltons or greater, about 5000 Daltons or greater, about 10,000 Daltons or greater, about 15,000 Daltons or less, about 20,000 Daltons or less, about 25,000 Daltons or less, about 30,000 Daltons or less, about 35,000 Daltons or less, about 40,000 Daltons or less, about 45,000 Daltons or less, about 50,000 Daltons or less, or any value encompassed by these endpoints.

Suitable surface active wetting and dispersing additives may be added, and include polycarboxylate salts, polycarboxylate ethers, styrene-maleic anhydride copolymers and derivatives, fatty acid derivatives, ethoxylated alcohols, and other copolymers with pigment affinic groups.

The water-soluble and/or surface active wetting and dispersing additives may be present in an anionic form in the aqueous pigment composition. The pH of the aqueous pigment composition may have a pH value of about 6 or greater, about 6.5 or greater, about 7 or greater, about 7.5 or greater, about 8 or less, about 8.5 or less, about 9 or less, about 9.5 or less, about 10 or less, or any value encompassed by these endpoints.

The water-soluble and/or surface active wetting and dispersing additives may be present in the aqueous pigment composition in an amount of about 0.01 wt. % or greater, about 0.1 wt. % or greater, about 0.5 wt. % or greater, about 1 wt. % or greater, about 2 wt. % or greater, about 3 wt. % or greater, about 4 wt. % or greater, about 5 wt. % or less, about 6 wt. % or less, about 7 wt. % or less, about 8 wt. % or less, about 9 wt. % or less, about 10 wt. % or less, or any value encompassed by these endpoints.

The colorant compositions optionally contain lecithin-based additives, which may include phospholipids, which are composed of fatty acids, glycerol, phosphoric acid and choline. The fatty acids may be saturated or unsaturated. The lecithins may generally be present in amphoteric form. If desired, the lecithin-based additive may be combined with anionic phosphoric ester and/or phosphonic ester.

As noted above, the colorant compositions optionally contain lecithin-based additives. If present, the lecithin-based additive or combination of lecithin-based additive and anionic phosphoric ester and/or phosphonic ester may be present in the aqueous pigment composition in an amount of about 0 wt. %, about 0.1 wt. % or greater, about 0.5 wt. % or greater, about 1 wt. % or greater, about 1.5 wt. % or greater, about 2 wt. % or greater, about 2.5 wt. % or greater, about 3 wt. % or greater, about 3.5 wt. % or greater, about 4 wt. % or less, about 4.5 wt. % or less, about 5 wt. % or less, about 5.5 wt. % or less, about 6 wt. % or less, about 6.5 wt. % or less, about 7 wt. % or less, about 7.5 wt. % or less, about 8 wt. % or less, or any value encompassed by these endpoints, based on the total weight of the aqueous pigment composition.

The optional additives may be those that are conventionally used in aqueous pigment compositions for paints, varnishes and renders. Examples of said additives may be humectants, rheology additives like thickeners, further dispersants such as nonionic additives based on polyethers, wetting agents, defoamers, foam suppressants, preservatives like biocides or fungicides, anti-flocculants, buffer substances, pH regulators and pigment synergists. Additions of this kind are known for aqueous pigment compositions to the skilled person.

The optional additives may be present in the aqueous pigment composition in an amount of 0 wt. %, about 0.1 wt. % or greater, about 0.5 wt. % or greater, about 1 wt. % or greater, about 5 wt. % or greater, about 10 wt. % or less, about 15 wt. % or less, about 20 wt. % or less, or any value encompassed by these endpoints.

The amount of water in the present pigment composition may be about 5 wt. % or greater, about 10 wt. % or greater, about 15 wt. % or greater, about 20 wt. % or greater, about 25 wt. % or greater, about 30 wt. % or less, about 35 wt. % or less, about 40 wt. % or less, about 45 wt. % or less, about 50 wt. % or less, about 55 wt. % or less, about 60 wt. % or less, or any value encompassed by these endpoints, based of the total weight of the aqueous pigment composition.

The VOC content of the pigment composition may be about 4 to 30 g/L, for example 4 to 20 g/L, for example 4 to 15 g/L.

### III. Biocides

Traditional biocides for use in aqueous media include methylisothiazolinone (MIT), benzisothiazolinone (BIT), and methylchloroisothiazolinone (CIT). However, safety concerns have been noted with the use of these products. Skin sensitization with MIT, for example, may be a concern. The present disclosure provides a formulation for a metal-based biocide. Suitable metal-based biocides may include Group 11 metal-based biocides, such as copper, silver, or gold, for example.

Specifically, the present disclosure provides an encapsulated copper product that may be used alone or in combination with traditional biocides to control microbial growth. The copper may be encapsulated in glass, for example.

The use of a copper biocide, for example, allows more traditional biocides to be used at reduced levels, or eliminated altogether. In contrast to the traditionally used biocides, copper is a low toxicity antimicrobial and is not a known skin sensitizer. The use of copper in pigment dispersions lowers health risks for both end users and manufacturers.

Pigment dispersions containing copper as described herein have a shelf life greater than those without the copper additive. Degradation is less than what is seen with traditional biocides like MIT and/or BIT. Specifically, storage stability of the pigment dispersions containing copper were subjected to accelerated aging studies, as described further below. Following these studies, no deterioration or corrosion was observed, nor was a decrease in potency, over conditions equivalent to 6 months to one year of storage.

The present disclosure provides an encapsulated copper product which enables the slow release of the copper antimicrobial. Slow release of the copper active from the encapsulated biocidal product over time allows the colorant to remain protected for longer periods of time, such as the shelf life of the pigment dispersion. Furthermore, the encapsulated copper product exhibits greater than 99.9% reduction in S. aureus, P. aeruginosa, K. aerogenes, and E. coli colony counts using the EPA test method.

The present disclosure provides antimicrobial copper particles comprising copper(I) oxide encapsulated in glass. The glass may provide a barrier to oxygen, which may assist in stabilizing copper(I) and preventing its oxidation to copper(II) upon exposure to the environment.

Specifically, the present disclosure provides an alkali copper aluminoborophosphosilicate glass ceramic material that may act as a delivery system for Cu(I) ions. In order to permit the antimicrobial copper ions to be extracted from the glass, a glass composition that separates into one higher durability matrix phase and one lower durability phase that contains the copper(I) may be used. One possible composition of the glass-encapsulated copper is shown below in Table 1.

TABLE 1

| Component | Mol % |
|---|---|
| SiO₂ | 60.12 |
| Al₂O₃ | 1.67 |
| CuO | 3.98 |
| Cu₂O | 14.64 |
| K₂O | 6.98 |
| P₂O₅ | 5.38 |
| B₂O₃ | 7.23 |

The glass-encapsulated copper particles may be jet milled to provide a weight average particle diameter of about 1 um or greater, about 1.5 um or greater, 2 um or greater, 2.5 um or greater, about 3 um or greater, about 3.5 um or greater, about 4 um or greater, about 4.5 um or greater, about 5 um or less, about 5.5 um or less, about 6 um or less, about 6.5 um or less, about 7 um or less, about 7.5 um or less, about 8 um or less, about 8.5 um or less, about 9 um or less, about 9.5 um or less, about 10 um or less, or any value encompassed by these endpoints. The weight average particle diameter is usually determined by light scattering methods, e.g., by the method of ISO 13320:2009.

The glass-encapsulated copper particles may be present in the aqueous pigment dispersion in an amount of 0.1 wt. % or greater, about 0.2 wt. % or greater, about 0.3 wt. % or greater, about 0.4 wt. % or greater, about 0.5 wt. % or less, about 0.6 wt. % or less, about 0.7 wt. % or less, about 0.8 wt. % or less, about 0.9 wt. % or less, about 1 wt. % or less, or any value encompassed by these endpoints, as a percentage of the total aqueous pigment dispersion.

### IV. Method of Making

The aqueous pigment formulations of the present disclosure may be prepared by introducing the pigment, the water-soluble and/or wetting and dispersing additives, and optionally a lecithin-based additive and/or optionally an anionic additive based on a phosphoric ester and/or phosphonic ester into water to form a suspension. The suspension is then subjected to wet comminution, such as grinding in a closed media mill or a sand mill. The glass-encapsulated copper may then be added, along with any further optional additives.

It may be desirable to add a portion of one or more optional additives prior to grinding. For example, the addition of one or more defoamers, wetting agents, and/or nonionic dispersants may take place prior to grinding. Thickeners may be added either during or after grinding in order to achieve the desired viscosity for the pigment composition. The glass-encapsulated antimicrobial copper particles may also be incorporated during or after grinding.

By way of non-limiting illustration, examples of certain embodiments of the present disclosure are given below.

### EXAMPLES

### Example 1: Glass Preparation

The glass materials were prepared from boalin sand (Coarse Berkely Fine Special, available from US Silica), calcined alumina (A2, Unground Classified, available from Almatis), cupric oxide (325 mesh, available from Ceramic Color and Chemical), aluminum metaphosphate (Technical Grade powder, available from Chemical Distributors, Inc.), and potassium carbonate (food additive grade, available from Amrex Chemical). The starting materials were mixed in a Turbula mixer, then melted for six hours at 1600° C. in covered fused quartz crucibles. The molten mixture was then poured from the crucibles onto a clean, stainless steel table, then transferred to an annealing furnace set to the appropriate annealing point for the glass. The glass was heat treated at its annealing point temperature for six hours, then cooled to room temperature at a rate of 100° C. per hour.

### Example 2: Paint Formulations

Several colorant preparations were formulated in different colors, using no biocide, varying amounts of glass-encapsulated copper, and glass-encapsulated copper in conjunction with another biocide. Sample colorant formulations are shown below in Tables 2-4, in which MIT, BIT, and CIT are as defined above, ZnP is zinc pyrithione, and IPBC is iodopropynyl butylcarbamate, a fungicide. Biocide 1 contains 10% BIT, 5% MIT, and 1% CIT. Biocide 2 contains 5.75% BIT and 5.75% ZnP.

The sample colorant formulations in Tables 2-4 were subjected to microbial screening tests to determine wet state bacterial resistance of the colorant preparations with various preservative packages, or no preservative. All samples were free from microbial contamination when the study began. Samples were tested using method B-720-US. Each sample was dosed with inoculum (containing the bacterial organisms listed in Table 5) three times at the levels indicated in Tables 6-8. Bacterial growth was determined 2 and 5 days after each dose, as well as 12 days after the 3^{rd} dose. Results are given in Tables 6-8. All white and green colorant formulations (except KG1 and DG1 positive controls without any preservative) showed excellent wet state bacterial resistance. Red colorant formulations showed excellent wet state bacterial resistance when 0.2% glass-encapsulated copper was used in conjunction with either 0.2% biocide 1 or 0.2% biocide 2, or when 0.4% glass-encapsulated copper was used in conjunction with 0.1% biocide 1.

TABLE 2

| Formula | | | MIT | BIT | CIT | ZnP | IPBC |
|---|---|---|---|---|---|---|---|
| ID | Color | Biocide | ppm | ppm | ppm | ppm | ppm |
| KG1 | White | None | 0 | 0 | 0 | 0 | 0 |
| KG2 | White | 0.2% glass- | 0 | 0 | 0 | 0 | 1500 |
| | | encapsulated copper | | | | | |
| KG3 | White | 0.4% glass- | 0 | 0 | 0 | 0 | 1500 |
| | | encapsulated copper | | | | | |
| KG4 | White | 0.2% biocide 1 + 0.2% | 95 | 190 | 19 | 0 | 1500 |
| | | glass-encapsulated | | | | | |
| | | copper | | | | | |
| KG5 | White | 0.1% biocide 1 + 0.4% | 50 | 200 | 10 | 0 | 1500 |
| | | glass-encapsulated | | | | | |
| | | copper | | | | | |
| KG6 | White | 0.2% biocide 2 + 0.2% | 0 | 108.3 | 0 | 108.3 | 1500 |
| | | glass-encapsulated | | | | | |
| | | copper | | | | | |
| KG7 | White | 0.1% biocide 2 + 0.4% | 0 | 57 | 0 | 57 | 1500 |
| | | glass-encapsulated | | | | | |
| | | copper | | | | | |

TABLE 3

| Formula | | | MIT | BIT | CIT | ZnP | IPBC |
|---|---|---|---|---|---|---|---|
| ID | Color | Biocide | ppm | ppm | ppm | ppm | ppm |
| DG1 | Green | None | 0 | 0 | 0 | 0 | 0 |
| DG2 | Green | 0.2% glass- | 0 | 0 | 0 | 0 | 1500 |
| | | encapsulated copper | | | | | |
| DG3 | Green | 0.4% glass- | 0 | 0 | 0 | 0 | 1500 |
| | | encapsulated copper | | | | | |
| DG4 | Green | 0.2% biocide 1 + 0.2% | 95 | 190 | 19 | 0 | 1500 |
| | | glass-encapsulated | | | | | |
| | | copper | | | | | |
| DG5 | Green | 0.1% biocide 1 + 0.4% | 50 | 200 | 10 | 0 | 1500 |
| | | glass-encapsulated | | | | | |
| | | copper | | | | | |
| DG6 | Green | 0.2% biocide 2 + 0.2% | 0 | 108.3 | 0 | 108.3 | 1500 |
| | | glass-encapsulated | | | | | |
| | | copper | | | | | |
| DG7 | Green | 0.1% biocide 2 + 0.4% | 0 | 57 | 0 | 57 | 1500 |
| | | glass-encapsulated | | | | | |
| | | copper | | | | | |

TABLE 4

| Formula | | | MIT | BIT | CIT | ZnP | IPBC |
|---|---|---|---|---|---|---|---|
| ID | Color | Biocide | ppm | ppm | ppm | ppm | ppm |
| RG1 | Red | None | 0 | 0 | 0 | 0 | 0 |
| RG2 | Red | 0.2% glass- | 0 | 0 | 0 | 0 | 1500 |
| | | encapsulated copper | | | | | |
| RG3 | Red | 0.4% glass- | 0 | 0 | 0 | 0 | 1500 |
| | | encapsulated copper | | | | | |
| RG4 | Red | 0.2% biocide 1 + 0.2% | 95 | 190 | 19 | 0 | 1500 |
| | | glass-encapsulated | | | | | |
| | | copper | | | | | |
| RG5 | Red | 0.1% biocide 1 + 0.4% | 50 | 200 | 10 | 0 | 1500 |
| | | glass-encapsulated | | | | | |
| | | copper | | | | | |
| RG6 | Red | 0.2% biocide 2 + 0.2% | 0 | 108.3 | 0 | 108.3 | 1500 |
| | | glass-encapsulated | | | | | |
| | | copper | | | | | |
| RG7 | Red | 0.1% biocide 2 + 0.4% | 0 | 57 | 0 | 57 | 1500 |
| | | glass-encapsulated | | | | | |
| | | copper | | | | | |

TABLE 5
Wet State Bacterial Resistance Test Inoculum
Preparation Test Method: B-723-US

| | Culture |
|---|---|
| Bacterial Organisms | Reference No. |
| Escherichia coli | ATCC 9723 |
| Pseudomonas aeruginosa | ATCC 10145 |
| Pseudomonas putida | ATCC 12633 |
| Burkholderia cepacia | ATCC 25416 |
| Staphylococcus aureus | ATCC 6538 |
| Alcaligenes faecalis | ATCC 8748 |
| Enterobacter gergoviae | AC 13652-15 |
| Alcaligenes xylosoxidans | AC 13652-19 |
| Pseudomonas aeruginosa | AC 13652-19 |

TABLE 6

| Wet State Bacterial | | | Degree of Microbial Growth | | | | | | |
|---|---|---|---|---|---|---|---|---|---|
| Resistance Test: | | | Nutrient Agar | | | | | | |
| B-720-US | | | 1st | | 2nd | | 3rd | | |
| Inoculum: Standard | | | Inocu- | | Inocu- | | Inocu- | | |
| wet state bacterial | | | lation | | lation | | lation | | |
| organisms (Table 8) | | | 1.8 × 10⁹ | | 2.4 × 10⁹ | | 3.0 × 10⁹ | | |
| For- | | | (cfu/mL) | | (cfu/mL) | | (cfu/mL) | | |
| mula | | | 2 | 5 | 2 | 5 | 2 | 5 | 12 |
| ID | Color | Biocide | Day | Day | Day | Day | Day | Day | Day |
| KG1 | White | None | 6 | 6 | 6 | 6 | 6 | 6 | 6 |
| KG2 | White | 0.2% | 0 | 0 | 0 | 0 | 0 | 0 | 0 |
| | | glass- | | | | | | | |
| | | encap- | | | | | | | |
| | | sulated | | | | | | | |
| | | copper | | | | | | | |
| KG3 | White | 0.4% | 0 | 0 | 0 | 0 | 0 | 0 | 0 |
| | | glass- | | | | | | | |
| | | encap- | | | | | | | |
| | | sulated | | | | | | | |
| | | copper | | | | | | | |
| KG4 | White | 0.2% | 0 | 0 | 0 | 0 | 0 | 0 | 0 |
| | | biocide | | | | | | | |
| | | 1 + 0.2% | | | | | | | |
| | | glass- | | | | | | | |
| | | encap- | | | | | | | |
| | | sulated | | | | | | | |
| | | copper | | | | | | | |
| KG5 | White | 0.1% | 0 | 0 | 0 | 0 | 0 | 0 | 0 |
| | | biocide | | | | | | | |
| | | 1 + 0.4% | | | | | | | |
| | | glass- | | | | | | | |
| | | encap- | | | | | | | |
| | | sulated | | | | | | | |
| | | copper | | | | | | | |
| KG6 | White | 0.2% | 0 | 0 | 0 | 0 | 0 | 0 | 0 |
| | | biocide | | | | | | | |
| | | 2 + 0.2% | | | | | | | |
| | | glass- | | | | | | | |
| | | encap- | | | | | | | |
| | | sulated | | | | | | | |
| | | copper | | | | | | | |
| KG7 | White | 0.1% | 0 | 0 | 0 | 0 | 0 | 0 | 0 |
| | | biocide | | | | | | | |
| | | 2 + 0.4% | | | | | | | |
| | | glass- | | | | | | | |
| | | encap- | | | | | | | |
| | | sulated | | | | | | | |
| | | copper | | | | | | | |

Bacterial Growth Key:
0 = no growth
1 = very scant (1-10 colonies)
2 = scant (11-100 colonies)
3 = light (101-300 colonies)
4 = moderate (301-400 colonies)
5 = heavy (401-500 colonies)
6 = dense (>500 colonies—blanket of growth)
Inoculum Volume: Standard inoculum volume = 1 mL into 50 g of sample

TABLE 7

| | | | Degree of Microbial Growth | | | | | | |
|---|---|---|---|---|---|---|---|---|---|
| | | | Nutrient Agar | | | | | | |
| | | | 1st | | 2nd | | 3rd | | |
| | | | Inocu- | | Inocu- | | Inocu- | | |
| | | | lation | | lation | | lation | | |
| | | | 1.8 × 10⁹ | | 2.4 × 10⁹ | | 3.0 × 10⁹ | | |
| For- | | | (cfu/mL) | | (cfu/mL) | | (cfu/mL) | | |
| mula | | | 2 | 5 | 2 | 5 | 2 | 5 | 12 |
| ID | Color | Biocide | Day | Day | Day | Day | Day | Day | Day |
| DG1 | Green | None | 6 | 6 | 6 | 6 | 6 | 6 | 6 |
| DG2 | Green | 0.2% | 0 | 0 | 0 | 0 | 0 | 0 | 0 |
| | | glass- | | | | | | | |
| | | encap- | | | | | | | |
| | | sulated | | | | | | | |
| | | copper | | | | | | | |
| DG3 | Green | 0.4% | 0 | 0 | 0 | 0 | 0 | 0 | 0 |
| | | glass- | | | | | | | |
| | | encap- | | | | | | | |
| | | sulated | | | | | | | |
| | | copper | | | | | | | |
| DG4 | Green | 0.2% | 0 | 0 | 0 | 0 | 0 | 0 | 0 |
| | | biocide | | | | | | | |
| | | 1 + 0.2% | | | | | | | |
| | | glass- | | | | | | | |
| | | encap- | | | | | | | |
| | | sulated | | | | | | | |
| | | copper | | | | | | | |
| DG5 | Green | 0.1% | 0 | 0 | 0 | 0 | 0 | 0 | 0 |
| | | biocide | | | | | | | |
| | | 1 + 0.4% | | | | | | | |
| | | glass- | | | | | | | |
| | | encap- | | | | | | | |
| | | sulated | | | | | | | |
| | | copper | | | | | | | |
| DG6 | Green | 0.2% | 0 | 0 | 0 | 0 | 0 | 0 | 0 |
| | | biocide | | | | | | | |
| | | 2 + 0.2% | | | | | | | |
| | | glass- | | | | | | | |
| | | encap- | | | | | | | |
| | | sulated | | | | | | | |
| | | copper | | | | | | | |
| DG7 | Green | 0.1% | 0 | 0 | 0 | 0 | 0 | 0 | 0 |
| | | biocide | | | | | | | |
| | | 2 + 0.4% | | | | | | | |
| | | glass- | | | | | | | |
| | | encap- | | | | | | | |
| | | sulated | | | | | | | |
| | | copper | | | | | | | |

Bacterial Growth Key:
0 = no growth
1 = very scant (1-10 colonies)
2 = scant (11-100 colonies)
3 = light (101-300 colonies)
4 = moderate (301-400 colonies)
5 = heavy (401-500 colonies)
6 = dense (>500 colonies—blanket of growth)
Inoculum Volume: Standard inoculum volume = 1 mL into 50 g of sample

TABLE 8

| | | | Degree of Microbial Growth | | | | | | |
|---|---|---|---|---|---|---|---|---|---|
| | | | Nutrient Agar | | | | | | |
| | | | 1st | | 2nd | | 3rd | | |
| | | | Inocu- | | Inocu- | | Inocu- | | |
| | | | lation | | lation | | lation | | |
| | | | 1.8 × 10⁹ | | 2.4 × 10⁹ | | 3.0 × 10⁹ | | |
| For- | | | (cfu/mL) | | (cfu/mL) | | (cfu/mL) | | |
| mula | | | 2 | 5 | 2 | 5 | 2 | 5 | 12 |
| ID | Color | Biocide | Day | Day | Day | Day | Day | Day | Day |
| RG1 | Red | None | 6 | 6 | 6 | 6 | 6 | 6 | 6 |
| RG2 | Red | 0.2% | 1 | 0 | 2 | 0 | 3 | 3 | 3 |
| | | glass- | | | | | | | |
| | | encap- | | | | | | | |
| | | sulated | | | | | | | |
| | | copper | | | | | | | |
| RG3 | Red | 0.4% | 0 | 0 | 4 | 3 | 4 | 4 | 5 |
| | | glass- | | | | | | | |
| | | encap- | | | | | | | |
| | | sulated | | | | | | | |
| | | copper | | | | | | | |
| RG4 | Red | 0.2% | 0 | 0 | 1 | 0 | 0 | 0 | 0 |
| | | biocide | | | | | | | |
| | | 1 + 0.2% | | | | | | | |
| | | glass- | | | | | | | |
| | | encap- | | | | | | | |
| | | sulated | | | | | | | |
| | | copper | | | | | | | |
| RG5 | Red | 0.1% | 0 | 0 | 0 | 0 | 0 | 0 | 0 |
| | | biocide | | | | | | | |
| | | 1 + 0.4% | | | | | | | |
| | | glass- | | | | | | | |
| | | encap- | | | | | | | |
| | | sulated | | | | | | | |
| | | copper | | | | | | | |
| RG6 | Red | 0.2% | 0 | 0 | 0 | 0 | 0 | 0 | 0 |
| | | biocide | | | | | | | |
| | | 2 + 0.2% | | | | | | | |
| | | glass- | | | | | | | |
| | | encap- | | | | | | | |
| | | sulated | | | | | | | |
| | | copper | | | | | | | |
| RG7 | Red | 0.1% | 0 | 0 | 4 | 3 | 6 | 5 | 5 |
| | | biocide | | | | | | | |
| | | 2 + 0.4% | | | | | | | |
| | | glass- | | | | | | | |
| | | encap- | | | | | | | |
| | | sulated | | | | | | | |
| | | copper | | | | | | | |

Bacterial Growth Key:
0 = no growth
1 = very scant (1-10 colonies)
2 = scant (11-100 colonies)
3 = light (101-300 colonies)
4 = moderate (301-400 colonies)
5 = heavy (401-500 colonies)
6 = dense (>500 colonies—blanket of growth)
Inoculum Volume: Standard inoculum volume = 1 mL into 50 g of sample

### Example 3: Bactericidal Efficacy

Bactericidal efficacy testing, including study controls, was performed as described in the EPA test for efficacy of copper allow surfaces as a sanitizer. Each test was repeated three times.

In each case, a coupon was prepared by mixing glass-encapsulated copper with commercial paints for 3-5 minutes. The formulation contained 26 g/L of the glass-encapsulated copper particles. The 1″×1″ test copons (BYK-Gardner 5015 byko-chart black scrub test panels P121-10N) were painted with primer and allowed to dry overnight at ambient temperature and humidity. Two coats of the paint containing the glass-encapsulated copper were applied (3 mils each). Each layer was allowed to dry for at least 24 hours. Untreated controls were prepared similarly, using paint without the glass-encapsulated copper additive. Prior to testing, the coupons were exposed to ultraviolet light (245 nm) on both sides for about 15 minutes.

Four bacterial strains were tested: S. aureus, K. aerogenes, P. aueruginosa, and E. coli. A 20 microliter aliquot of each bacterial culture was added to 10 mL Tryptic Soy Broth. The bacterial suspensions were serially incubated three times at 36° C. (30° C. for K. aerogenes) for 18-24 hours in an orbital shaker, then once in polypropylene snap tubes for 48 hours. The cultures were then mixed on a vortex mixer and allowed to settle. The upper two thirds of the suspension in each tube was aspirated and the OD₆₀₀ was measured (Smart Spec Spectrophotometer 3000, Bio-Rad) for estimation of bacterial density. The culture was diluted with phosphate buffer saline to a target concentration of 1.0×10⁷ colony-forming units (CFU) per mL. Organic soil load including 0.25 mL of 5% fetal bovine serum (Gibco Life Technologies) and 0.05 mL Triton X-100 (Amresco Pro Pure) was added to 4.70 mL of the bacterial suspension to aid in spreading the inoculum.

Each coupon was inoculated with 20 microliters of the bacterial test culture, then incubated at 42% relative humidity and 23° C. for 120 min. Following the test period, the coupons were neutralized in Letheen broth (Gen Lab). Ten-fold serial dilutions of the neutralized solutions were plated on Tryptic Soy Agar plates and incubated for 48 hours at 36° C. (30° C. for K. aerogenes). The results are shown below in Table 9.

TABLE 9

| Organism | CFU/control coupon | CFU/test coupon | Log kill |
|---|---|---|---|
| S. aureus | 4.33E+05 | ≤10 | ≥4.64 |
| P. auruginosa | 1.46E+05 | ≤10 | ≥4.41 |
| E. Coli | 2.59E+05 | ≤10 | ≥4.16 |
| K. aerogenes | 1.63E+05 | ≤10 | ≥4.21 |

1.-12. (canceled)

13. An aqueous pigment composition comprising:
a pigment;
a water-soluble additive comprising a water-soluble polyamine and/or a wetting and dispersing additive;
a Group 11 metal-based biocide; and
water.

14. The composition of claim 13, wherein the Group 11 metal-based biocide comprises copper.

15. The composition of claim 13, wherein the Group 11 metal-based biocide comprises glass-encapsulated copper particles.

16. The composition of claim 13, wherein the Group 11 metal-based biocide comprises glass-encapsulated copper(I) ions.

17. The composition of claim 15, wherein the glass-encapsulated copper particles have an average diameter of 1 um to 10 um.

18. The composition of claim 13, wherein the Group 11 metal-based biocide is present in the aqueous pigment composition in an amount of 0.1 wt. % to 1 wt. %, as a percentage of the total composition.

19. The composition of claim 13, wherein the Group 11 metal-based biocide is present in the aqueous pigment composition in an amount of 0.2 wt. % to 0.4 wt. %, as a percentage of the total composition.

20. The composition of claim 13, wherein the pigment is present in the aqueous pigment composition in an amount of 1 wt. % to 80 wt. %, as a percentage of the total preparation.

21. The composition of claim 13, wherein the water-soluble and/or wetting and dispersing additive is present in the aqueous pigment composition in an amount of 0.1 wt. % to 10 wt. %, as a percentage of the total preparation.

22. The composition of claim 13, further comprising at least one additional biocide or fungicide.

23. The composition of claim 13, further comprising at least one of humectants, rheology additives, dispersants, wetting agents, defoamers, foam suppressants, anti-flocculants, buffer substances, pH regulators and pigment synergists.

24. The composition of claim 13, wherein the water-soluble and/or wetting and dispersing additive comprises at least one polyamine, and/or a wetting and dispersing additive comprising at least one polycarboxylate salt, polycarboxylate ether, styrene-maleic anhydride copolymer or derivative, fatty acid derivative, ethoxylated alcohol, or copolymer with pigment affinic groups.
